(19) United States
(12) Patent Application Publication
(10) Pub. No.: US 2018/0268640 A1
(43) Pub. Date: Sep. 20, 2018

(54) Vending Machine

(71) Applicants: Sanden Holdings Corporation, Isesaki-shi (JP); The Coca-Cola Company, Atlanta, GA (US)

(72) Inventors: Mototaka TADIKA, Isesaki-shi (JP); Yasuhiro Yamazaki, Koto-ku (JP); Takashi Nishiyama, Koto-ku (JP)

(21) Appl. No.: 15/537,601

(22) PCT Filed: Dec. 18, 2015
(86) PCT No.: PCT/JP2015/085552

§ 371 Date: Jun. 19, 2017

(30) Foreign Application Priority Data
Dec. 19, 2014 (JP) 2014-257773

(51) Int. Cl. G07F 9/10

(52) U.S. Cl. CPC G07F 9/105; G07F 17/0014

(57) ABSTRACT

Automatic vending machine (100) having: product storage device (4) arranged inside heat-insulated chamber (1a); cooling device (30) cooling products (C); control unit (40); and back-side duct (6). Pooling device (30) has: compressor (21); condenser (22); expansion mechanism (23); and evaporator (11) provided inside chamber (1a) and evaporating a refrigerant to cool ambient air, and cools products (C) by cooling the air in chamber (1a) and circulating air through back side duct (6). Expansion mechanism (23) has electronic expansion valve (23a) capable of adjusting aperture of a refrigerant flow path, and in both a case of partial cooling operation and a case of entire cooling operation, control unit (40) executes aperture control of controlling aperture (S) of electronic expansion valve (23a) so that a temperature difference (ΔT) between a temperature of the inside of chamber (1a) and refrigerant evaporation temperature (T3) of the evaporator (11) are within a predetermined range.

### TECHNICAL FIELD

The present invention relates to an automatic vending machine which cools products for sale.

### BACKGROUND ART

An automatic beverage vending machine disclosed in Patent Document 1 and an automatic frozen beverage vending machine disclosed in Patent Document 2 are each known as an example of an automatic vending machine which cools products for sale.

A heat-insulated chamber is formed inside the automatic beverage vending machine disclosed in Patent Document 1, and a product storage device which vertically arrays and stores a plurality of products and also sequentially dispenses the products starting with the product located at a lowermost part is provided at an upper part inside the heat-insulated chamber. A cooling device which cools the air inside the heat-insulated chamber is provided below the product storage device. The cooling device includes a compressor, a condenser, an evaporator, and an evaporator fan. Driving the evaporator fan causes circulation of the air inside the heat-insulated chamber, which includes cool air around the evaporator generated by the evaporator, through a back-side duct. Then, the air inside the heat-insulated chamber is cooled. The cooling device cools the plurality of products inside the heat-insulated chamber by cooling the air inside the heat-insulated chamber.

Moreover, the automatic frozen beverage vending machine disclosed in Patent Document 2 cools beverages (hereinafter referred to as “bottled beverages”) contained in plastic bottles or the like for sale. A frozen beverage chamber is formed inside the automatic frozen beverage vending machine. The frozen beverage chamber is adapted to be maintained at a set temperature at which the bottled beverages can be frozen. Then the automatic frozen beverage vending machine is configured so as to sequentially dispense the corresponding bottled beverages for sale when pressing product selection buttons.

The conventional automatic vending machines described above typically use a capillary tube as an expansion mechanism which decreases a pressure of a refrigerant condensed by the condenser of the cooling device.

### REFERENCE DOCUMENT LIST

### Patent Documents

Patent Document 1: Japanese Patent Application Laid-open Publication No. 2003-173465

Patent Document 2: Japanese Patent Application Laid-open Publication No. 2006-48325

### SUMMARY OF THE INVENTION

### Problems to be Solved by the Invention

The above-mentioned automatic vending machine is typically desired to achieve reduction of energy required for cooling the inside of the chamber and may also execute partial cooling operation for cooling the products located on a lower side inside the product storage device and entire cooling operation for cooling the entirety of the products inside the product storage device. Furthermore, the automatic frozen beverage vending machine disclosed in Patent Document 2 has a chamber (the frozen beverage chamber) of which the internal set temperature is lower than an internal set temperature of a chamber provided in conventional typical automatic beverage vending machines, for example, the automatic beverage vending machine disclosed in Patent Document 1, and has greater energy (an amount of power consumption) required for cooling the inside of the chamber than the conventional typical automatic beverage vending machines. Thus, the automatic frozen beverage vending machine has particularly been desired to reduce the energy required for cooling the inside of the chamber.

Here, for example, upon products filling into the chamber of the conventional automatic vending machines disclosed in Patent Documents 1 and 2, an inside temperature of the chamber is increased by outer air inflow. Upon cooling of the air inside the chamber after the increase in the inside temperature of the chamber, a difference between an actual temperature of the air around the products inside the chamber and a temperature of cool air (cool air temperature) generated around the evaporator, that is, a temperature difference between the actual temperature of the air around the products inside the chamber and a refrigerant evaporation temperature of the evaporator becomes larger. The probability of increase in the temperature difference occurring in the automatic frozen beverage vending machine in particular is high. In the cooling device, if an actual temperature of the inside of the chamber is constant, the temperature of the air around the products inside the chamber easily decreases as the temperature difference becomes larger. However, an excessively large temperature difference results in an increase in energy loss. Consequently, operating the cooling device in a state in which the temperature difference is excessively large is not preferable in terms of achieving the reduction of the energy required for cooling the inside of the chamber.

However, the above-mentioned automatic vending machines typically use the capillary tube as an expansion device, and is incapable of changing the refrigerant evaporation temperature in the evaporator in both the partial cooling operation and the entire cooling operation. Therefore, the cooling device is inevitably operated in the state in which the temperature difference is excessively large, thus leading to demands for taking measures for energy reduction.

Thus, it is an object of the present invention to provide an automatic vending machine capable of reducing the energy required for cooling the entire or partial inside of a chamber even in a situation in which a temperature difference between an actual temperature of the air around products inside the chamber and a refrigerant evaporation temperature of an evaporator may become larger.

### Means for Solving the Problems

According to one aspect of the present invention, an automatic vending machine is configured to include: a product storage device arranged inside a heat-insulated chamber, which vertically arrays and stores a plurality of products, and also sequentially dispenses the plurality of products starting with the product located at a lowermost part; a cooling device which cools the plurality of products; a control unit which controls the cooling device; and a back-side duct which is disposed on a back side inside the heat insulation chamber and extends heightwise of the heat-insulated chamber, in which the cooling device has: a compressor which compresses a refrigerant; a condenser which condenses the compressed refrigerant; an expansion mechanism which expands the condensed refrigerant; and an evaporator which is provided at a lower part inside the heat-insulated chamber and evaporates the refrigerant to cool ambient air, and the cooling device cools the plurality of products by cooling air inside the heat-insulated chamber and also circulating the air through the back-side duct, the expansion mechanism has an electronic expansion valve capable of adjusting aperture of a refrigerant flow path, and in both a case of partial cooling operation for cooling the product located on a lower side of the plurality of products by driving the cooling device and a case of the entire cooling operation for cooling the entirety of the plurality of products, the control unit controls aperture of the electronic expansion valve so that a temperature difference between a temperature of the inside of the heat-insulated chamber and a refrigerant evaporation temperature of the evaporator may be within a predetermined range.

### Effects of the Invention

In the automatic vending machine according to the present invention, the expansion mechanism for a refrigerant in the cooling device has the electronic expansion valve capable of adjusting aperture of a refrigerant flow path, and in both the case of the partial cooling operation and the case of the entire cooling operation, the aperture of the electronic expansion valve is controlled by the control unit so that the temperature difference between the temperature of the inside of the heat-insulated chamber and the refrigerant evaporation temperature of the evaporator may be within the predetermined range. Thus, in the automatic vending machine, it is possible to execute the partial cooling operation and the entire cooling operation so that the temperature difference between an actual temperature of the air around the products inside the heat-insulated chamber and the refrigerant evaporation temperature of the evaporator may be within the predetermined range. Therefore, for example, in the automatic vending machine, it is possible to adjust the aperture of the electronic expansion valve according to the increased temperature of the inside of the chamber to increase the refrigerant evaporation temperature to thereby make the temperature difference fall within the predetermined range in both the case of the partial cooling operation and the case of the entire cooling operation.

Therefore, the automatic vending machine is capable of reducing energy required for cooling the entire or partial inside of the chamber even in a situation in which the temperature difference between the actual temperature of the air around the products inside the heat-insulated chamber and the refrigerant evaporation temperature of the evaporator may become larger.

### BRIEF DESCRIPTION OF THE DRAWINGS

FIG. 1 is a perspective view illustrating an automatic vending machine according to one embodiment of the present invention.

FIG. 2 is a vertical sectional view illustrating the automatic vending machine of FIG. 1.

FIG. 3 is a conceptual view illustrating an air circulation status during partial cooling operation of the automatic vending machine illustrated in FIG. 1.

FIG. 4 is a control flow view illustrating aperture control performed by a control unit of the automatic vending machine of FIG. 1.

FIG. 5 is a conceptual view illustrating an air circulation status during the entire cooling operation of the automatic vending machine of FIG. 1.

FIG. 6 is a vertical sectional view illustrating a modified example (Modified Example 1) of the automatic vending machine of FIG. 1.

FIG. 7 is a vertical sectional view illustrating another modified example (Modified Example 2) of the automatic vending machine of FIG. 1.

### MODE FOR CARRYING OUT THE INVENTION

Hereinafter, an embodiment of the present invention will be described with reference to the accompanying drawings.

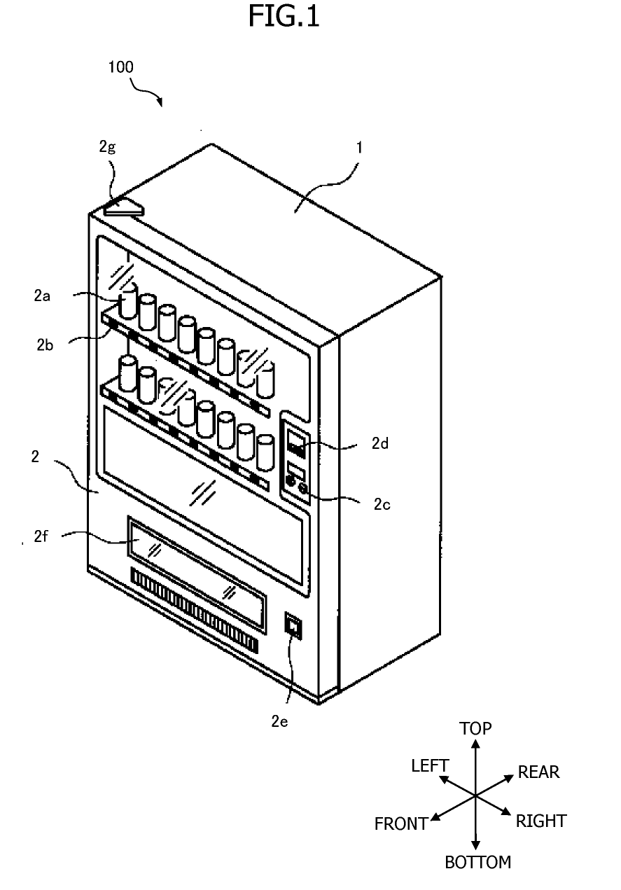

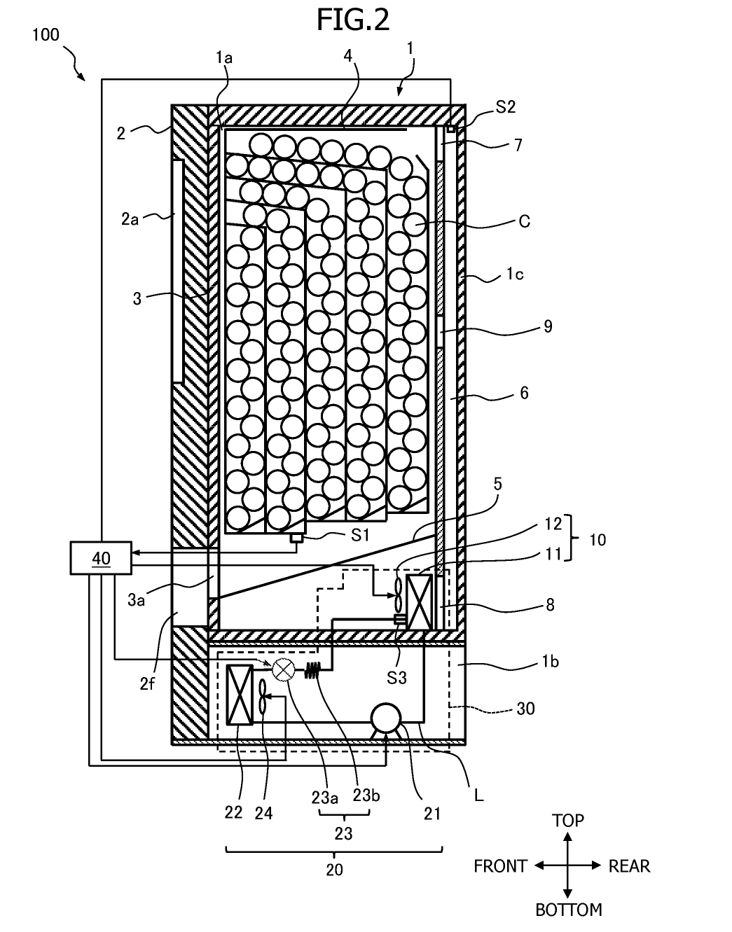

FIG. 1 illustrates an external view of an automatic vending machine according to one embodiment of the present invention. FIG. 2 illustrates a vertical cross section of the automatic vending machine.

Note that a front and a rear, a right and a left, and a top and a bottom of the automatic vending machine are conveniently defined as illustrated in FIG. 1 in the following description.

An automatic vending machine 100 according to the present embodiment is configured so as to be able to cool bottled beverages (beverages contained in plastic bottles) as products for sale, and to include: an automatic vending machine body 1 which has an open front surface; an outer door 2 which opens and closes the front surface of the automatic vending machine body 1; and an inner door 3 which opens and closes a front surface of a product storage chamber 1a, to be described later.

The automatic vending machine body 1 is partitioned into: the product storage chamber 1a for storing bottled beverages C; and a mechanical chamber 1b which accommodates various devices. The mechanical chamber 1b is located below the product storage chamber 1a. The automatic vending machine body 1 has the open front side and is formed with a heat-insulated wall 1c which surrounds the product storage chamber 1a. Note that the product storage chamber 1a in the present embodiment corresponds to “a heat-insulated chamber” according to the present invention.

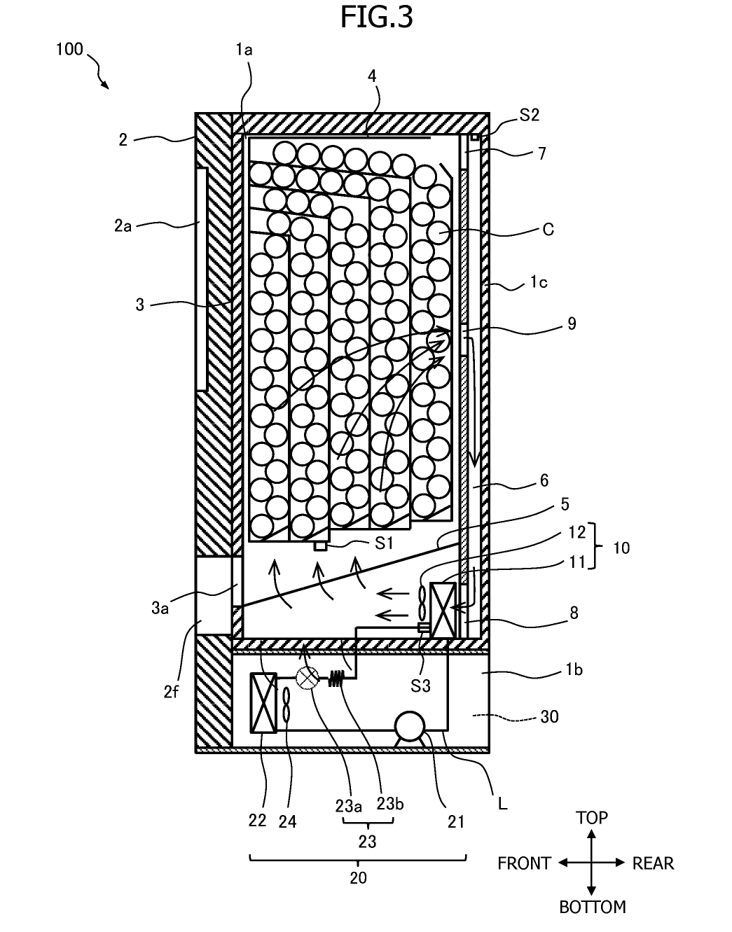

The product storage chamber 1a has the open front side and is formed with a heat-insulated structure which has a top side, a back side, a bottom side, and both right and left sides surrounded by the heat-insulated wall 1c. A product storage device 4 having a plurality of product storage columns (here, five product storage columns) in an anteroposterior direction is disposed inside the product storage chamber 1a. A product shooter 5 is provided below the product storage device 4. In addition, as illustrated in FIG. 3, for example, a cooling unit 10 of a cooling device 30, to be described later, for cooling the bottled beverages C is provided at a lower part of the product storage chamber 1a. Then a back-side duct 6 is provided on a back side inside the product storage chamber 1a. Note that the product storage device 4, the product shooter 5, the back-side duct 6, and the cooling device 30 will be described in detail later.

The outer door 2 is a door which opens and closes the front surface of the automatic vending machine body 1, includes, on the front surface, a product sample chamber 2a, product selection buttons 2b, a coin slot 2c, a bill slot 2d, a coin return opening 2e, a product outlet opening 2f, and the like, and has a widthwise one end side turnably supported at the automatic vending machine body 1 with an attachment plate 2g placed therebetween.

The inner door 3 is a door which opens and closes the front surface of the product storage chamber 1a inside the automatic vending machine body 1 and is also a door which is formed with a heat insulating material included therein. A plurality of product dispense openings 3a (two in the figure) which communicates together the product storage chamber 1a and the product outlet opening 2f is provided in an open manner in a width direction (lateral direction) at a lower part of the inner door 3 having heat insulating properties. When sales operation is performed by, for example, pressing the product selection button 2b, the bottled beverage C corresponding to the product selection button 2b drops downward from a lowermost part of any of the product storage columns storing the aforementioned bottled beverage C. Then the bottled beverage C makes a rolling movement along an oblique surface of the product shooter 5 and pushes and opens an inner door side flap attached to the product dispense opening 3a to release into the product outlet opening 2f.

The product storage device 4 is arranged inside the product storage chamber 1a, and is configured so as to be able to store a plurality of bottled beverages C of the same type vertically arrayed in the product storage column and also sequentially dispense the bottled beverages C starting with the bottled beverage C located at a lowermost part. The product storage device 4 is formed with a so-called serpentine mechanism. The product storage device 4 stores the bottled beverages C, which have been loaded from a product opening located on an upper end side, so as to vertically stack the bottled beverages C one on top of another in a meandering product path. Then the bottled beverages C are sequentially dropped towards the product shooter 5 one by one, starting with the bottled beverage C located at a lowermost end and then dispensed by the product dispensing mechanism provided at a lower end of the product storage device 4.

The product shooter 5 is provided below the product storage device 4, is a member of a flat plate-like shape having a large number of air holes, and is disposed inclined so as to extend downward towards a front side of the automatic vending machine 100.

The back-side duct 6 is disposed inside the product storage chamber 1a on a back side thereof to be provided so as to extend heightwise of the product storage chamber 1a, and the air blew by an internal blower fan 12, to be described later, of the cooling device 30 flows through the back-side duct 6.

More specifically, the back-side duct 6 extends from vicinity of an inner bottom part of the product storage chamber 1a to vicinity of a ceiling part thereof, and has: an upper opening part 7 which opens at an upper part inside the product storage chamber 1a; a lower opening part 8 which opens at the lower part inside the product storage chamber 1a; and a middle opening part 9 which opens at a middle part between the upper opening part 7 and the lower opening part 8.

In the present embodiment, the upper opening part 7 is formed so as to be located above the bottled beverage C stored at an uppermost part inside the product storage device 4, the lower opening part 8 is formed so as to be located below the product shooter 5; and the middle opening part 9 is formed so as to be located at a middle height position of the product storage device 4.

The cooling device 30 cools the plurality of bottled beverages C, has the cooling unit 10 and a condensing unit 20, and is configured so as to be able to cool the air inside the product storage chamber 1a and also circulate the air through the back-side duct 6 to thereby cool the plurality of bottled beverages C. The cooling unit 10 and the condensing unit 20 are connected together with the refrigerant pipe L in between, and circulates a refrigerant to thereby form the cooling device 30 capable of cooling the inside of the product storage chamber 1a.

The cooling unit 10 is provided at a lower part inside the product storage chamber 1a, more specifically, below the product shooter 5 and has an inside heat exchanger (evaporator) 11 and the internal blower fan 12.

The internal heat exchanger 11 evaporates a refrigerant to cool ambient air, and is disposed in vicinity of the lower opening part 8 of the back-side duct 6.

The internal blower fan 12 is disposed in vicinity of the internal heat exchanger 11 and circulates the air inside the heat-insulated chamber 1a, and adopts a fan capable of rotating in normal and reverse directions. Note that the internal heat exchanger 11 is arranged between the lower opening part 8 of the back-side duct 6 and the internal blower fan 12 here; however, the internal blower fan 12 may be arranged between the lower opening part 8 of the back-side duct 6 and the internal heat exchanger 11. Furthermore, the internal heat exchanger 11 and/or the internal blower fan 12 may be arranged in the back-side duct 6.

The condensing unit 20 is provided in the mechanical chamber 1b, and has: a compressor 21 which compresses the refrigerant; an external heat exchanger (condenser) 22 which condenses the compressed refrigerant; and an expansion mechanism 23 which expands the condensed refrigerant. The internal heat exchanger 11, the compressor 21, the external heat exchanger 22, and the expansion mechanism 23 are connected together with the refrigerant pipe L, which is provided to circulate the refrigerant, and an external blower fan 24 is disposed in vicinity of the external heat exchanger 22.

The expansion mechanism 23 has an electronic expansion valve 23a and a capillary tube 23b in the present embodiment.

The electronic expansion valve 23a is configured so as to be able to adjust the aperture of a refrigerant flow path. Increasing (opening) the aperture S of the electronic expansion valve 23a increases a refrigerant evaporation temperature T3 in the internal heat exchanger 11 while decreasing (narrowing down) the aperture of the electronic expansion valve 23a decreases the refrigerant evaporation temperature T3. Note that the electronic expansion valve 23a has upper and lower limit values (maximum aperture Smax and minimum aperture Smin) of the aperture S in the present embodiment.

The cooling device 30 circulates the air inside the product storage chamber 1a through the back-side duct 6 by the internal blower fan 12, and also circulates the refrigerant through the compressor 21, the external heat exchanger 22, the expansion mechanism 23, and the internal heat exchanger 11. The air inside the product storage chamber 1a is heat-exchanged with the refrigerant and thereby cooled upon passage through surroundings of the internal heat exchanger 11, so that the inside of the product storage chamber 1a and eventually the large number of bottled beverages C stored in each product storage device 4 may be cooled. Note that the internal heat exchanger 11 in the present embodiment corresponds to “an evaporator” of the invention, the internal blower fan 12 in the present embodiment corresponds to “a circulating fan” of the invention, and the external heat exchanger 22 in the present embodiment corresponds to “a condenser” of the invention.

Moreover, temperature sensors S1, S2, and S3 are provided inside the product storage chamber 1a.

The temperature sensor S1 is a sensor for measuring a temperature of a lower space (lower space temperature T1) inside the product storage chamber 1a, and is provided, for example, in vicinity of a lower part of the product storage device 4, more specifically, at a bottom part of the product storage device 4. Note that the temperature sensor S1 is only required to measure the temperature of the lower space inside the product storage chamber 1a, for example, a temperature of vicinity of the bottled beverage C stored at the lowermost part in the product storage device 4, and an installation position of the temperature sensor S1 is not limited to the bottom part of the product storage device 4.

The temperature sensor S2 is a sensor for measuring a temperature of an upper space (upper space temperature T2) inside the product storage chamber 1a, and is provided here, for example, in the back-side duct 6 and, more specifically, in the vicinity of the upper opening part 7 of the back-side duct 6. The temperature sensor S2 is only required to measure the temperature of the upper space inside the product storage chamber 1a, for example, a temperature of the vicinity of the bottled beverage C stored at an uppermost part in the product storage device 4, and an installation position of the temperature sensor S2 is not limited to the vicinity of the upper opening part 7 inside the back-side duct 6.

The temperature sensor S3 is a sensor for measuring the refrigerant evaporation temperature T3 of the internal heat exchanger 11, and is provided, for example, so as to be able to measure a refrigerant temperature on a refrigerant inlet side of the internal heat exchanger 11.

Note that the temperature sensor S1 in the present embodiment corresponds to “a first temperature measuring unit” of the present invention, the temperature sensor S2 in the present embodiment corresponds to “a second temperature measuring unit” of the present invention, and the temperature sensor S3 in the present embodiment corresponds to “a third temperature measuring unit” of the present invention.

Operation of the cooling device 30 is controlled by a control unit 40 here. The control unit 40 is provided, for example, at an appropriate portion inside the outer door 2. The product storage chamber 1a in the present embodiment is configured so as to function as a supercooling chamber of which the inside is cooled by the cooling device 30 to cool the bottled beverages C, stored in the product storage device 4, in a supercooled state. Thus, the control unit 40 controls the operation of the cooling device 30 so that a temperature of the inside of the product storage chamber 1a may be held at a set temperature TS at which the bottled beverages C are cooled and held in the supercooled state. The set temperature TS here is a temperature equal to or lower than a freezing point of the bottled beverages C, and it is possible to set the temperature at, for example, around −5° C. (approximately −2 to −8° C.).

Now, the temperature of the inside of the product storage chamber 1a is increased by outer air inflow, for example, when filling product into the product storage device 4. After the increase in the temperature of the inside of the product storage chamber 1a, pull-down operation for decreasing the temperature of the inside of the product storage chamber 1a to the set temperature TS is performed. There is a possibility that a difference between an actual temperature of the air around the products inside the product storage chamber 1a and a temperature of cool air (cool air temperature) generated around the internal heat exchanger 11, in other words, a temperature difference ΔT between the actual temperature of the air around the products inside the product storage chamber 1a and the refrigerant evaporation temperature T3, becomes excessively large. Therefore, it is required to control the temperature difference ΔT as appropriately as possible to achieve reduction of energy required for cooling the inside of the chamber.

Thus, the control unit 40 controls the operation of the cooling device 30, as described below.

The control unit 40 is configured so as to execute aperture control of controlling aperture of the electronic expansion valve 23a so that the temperature difference ΔT between the temperature of the inside of the product storage chamber 1a and the refrigerant evaporation temperature T3 of the internal heat exchanger 11 falls within a predetermined range (for example, approximately 8 to 13° C.).

For the aperture control, a target value ΔTs of the temperature difference ΔT is preset and also correspondence relationship of the aperture S according to the refrigerant evaporation temperature T3 is preset, for example, by a data table or an arithmetic equation in the control unit 40. Therefore, when the actual temperature of the inside of the product storage chamber 1a is measured, the control unit 40 is capable of subtracting the ΔTs from the actual temperature to thereby calculate the optimum refrigerant evaporation temperature T3 and also determining the aperture S corresponding to the T3 obtained through the calculation. For example, where the target value ΔTs is 10° C. and the actual temperature of the inside of the product storage chamber 1a is 5° C., the control unit 40 determines the aperture S with which the refrigerant evaporation temperature T3 is −5° C. (=actual temperature 5° C.−ΔTs), and outputs a control signal to the electronic expansion valve 23a so as to provide the determined aperture S. An actual temperature of the refrigerant evaporation temperature T3 is measured by the temperature sensor S3. A measured value is measured not for the purpose of determining the aperture S described above but for the purpose of simply confirming, after changing of the aperture S, whether or not the refrigerant evaporation temperature T3 has actually reached a temperature corresponding to the aperture S obtained after the changing.

Furthermore, in the aperture control, the electronic expansion valve 23a opens the aperture of the refrigerant flow path when the aperture S obtained after the changing is greater than the aperture S provided before the changing while the electronic expansion valve 23a narrows down the aperture of the refrigerant flow path when the aperture S obtained after the changing is smaller than the aperture S provided before the changing. Therefore, even with the actual temperature of the inside of the product storage chamber 1a constant, whether to narrow down or open the current aperture of the refrigerant flow path is determined depending on size relationship between the aperture S provided before the changing and the aperture S obtained after the changing.

Note that, in a case in which the refrigerant evaporation temperature T3 exceeds a permitted refrigerant evaporation temperature adjustment range having, as upper and lower limit values, an upper-limit refrigerant evaporation temperature (an upper-limit refrigerant temperature, for example, approximately 5° C.) T3H, which is defined according to the maximum aperture Smax of the electronic expansion valve 23a and a lower-limit refrigerant evaporation temperature (a lower-limit refrigerant temperature, for example, approximately −20° C.) T3L, which is defined according to the minimum aperture Smin of the electronic expansion valve 23a, the aperture is controlled at a maximum or a minimum. Specifically, describing, as one example, a case in which the target value ΔTs of the temperature difference ΔT is 10° C., the upper-limit refrigerant temperature T3H is 5° C., and the lower-limit refrigerant temperature T3L is −20° C., when the actual temperature of the inside of the product storage chamber 1a is equal to or greater than 15° C. (=T3H+ΔTs) or equal to or smaller than −10° C. (=T3L+ΔTs), the aperture is controlled at the maximum or the minimum. For example, the aperture S is set at the maximum aperture Smax when the actual temperature ≥T3H+ΔTs while the aperture S is set at the minimum aperture Smin when T3L+ΔTs≥the actual temperature.

Moreover, the control unit 40 is configured so as to selectively make switching between partial cooling operation of driving the cooling device 30 to cool the bottled beverages C located on a lower side of the plurality of bottled beverages C stored in the product storage device 4 and the entire cooling operation of driving the cooling device 30 to cool all the bottled beverages C stored in the product storage device 4, and to execute the aperture control in both a case of the partial cooling operation and a case of the entire cooling operation.

Then the control unit 40 is configured so as to reverse a rotation direction of the internal blower fan 12 between when the partial cooling operation is performed and when the entire cooling operation is performed. For example, the control unit 40 drives the internal blower fan 12 into normal rotation upon the execution of the partial cooling operation and drives the internal blower fan 12 into reverse rotation upon the execution of the entire cooling operation.

For example, the automatic vending machine 100 may be required to be able to execute the partial cooling operation to cool, at an appropriate temperature, only the plurality of bottled beverages C dischargeable upon next sales operation when the automatic vending machine 100 is installed at a place where a number of products sold per day is small; on the other hand, the automatic vending machine 100 may be required to be able to execute the entire cooling operation in order to suppress loss of sales opportunities when the automatic vending machine 100 is installed at a place where the number of products sold is large. Furthermore, the automatic vending machine 100 may also be required to be able to execute the partial cooling operation in order to reduce an amount of power consumption in, for example, a season in which electric power demands are high. Then the automatic vending machine 100 may also be required to be able to execute the entire cooling operation in nighttime in which the electric power demands are low, on the other hand, the automatic vending machine 100 may also be required to be able to execute cold storage operation of stopping the driving of the cooling device 30 in, for example, daytime in order to reduce the amount of power consumption in a time zone (for example, daytime) in, for example, summer in which the electric power demands are high.

Hereinafter, a case in which the partial cooling operation is executed and a case in which the entire cooling operation is executed will be described in detail separately from each other.

First, the partial cooling operation will be described.

For example, to execute the partial cooling operation during the pull-down operation, the control unit 40 drives the internal blower fan 12 and also actuates the compressor 21 and the external blower fan 24. Then, as illustrated in FIG. 3, the air inside the product storage chamber 1a circulates through the inside of the product storage chamber 1a so as to flow into the back-side duct 6 from the middle opening part 9, downwardly pass through an inside of the back-side duct 6, flow out from the lower opening part 8, and then flow into the back-side duct 6 from the middle opening part 9 again. In this case, the air that flows out from the lower opening part 8 is cooled by the internal heat exchanger 11, then passes through the air holes of the product shooter 5, passes between the bottled beverages C stored in the product storage device 4 from a bottom to a top, and travels towards the middle opening part 9 again. As a result, the lower space inside the product storage chamber 1a is cooled and also the plurality of (for example, 10 to 15) bottled beverages C stored on the lower side in each product storage device 4 are cooled.

More specifically, in the present embodiment, the control unit 40 uses, as the temperature difference ΔT, a difference between the temperature measured by the temperature sensor S1 (the lower space temperature T1) and the refrigerant evaporation temperature T3 upon the execution of the partial cooling operation during the pull-down operation.

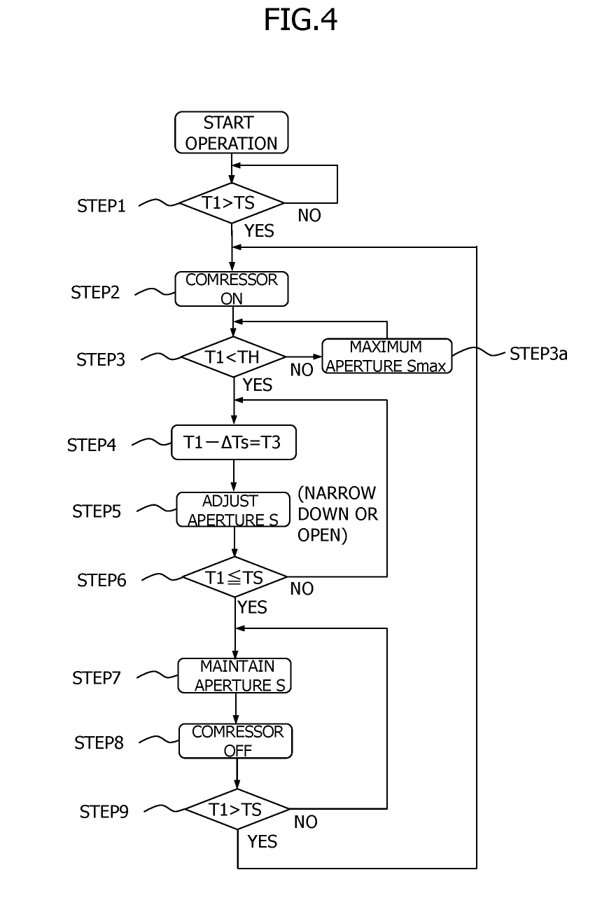

FIG. 4 illustrates a control flow view illustrating one example of the aperture control performed by the control unit 40. Hereinafter, the aperture control will be described in detail with reference to FIG. 4.

Note that the description will be given under the assumption that the temperature of the inside of the product storage chamber 1a is increased by the outer air inflow and then the partial cooling operation is executed as the pull-down operation, the set temperature TS is −5° C., the target value ΔTs of the temperature difference ΔT is 10° C., the upper-limit refrigerant temperature T3H is 5° C., and the lower-limit refrigerant temperature T3L is −20° C.

First, the control unit 40 acquires the lower space temperature T1 from the temperature sensor S1. The control unit 40 samples signals output from temperature sensor S1 at appropriate time intervals.

In Step 1, the control unit 40 determines whether or not the lower space temperature T1 is greater than the set temperature TS. Upon determination that T1>TS (YES in STEP 1), the process proceeds to STEP 2.

In Step 2, the control unit 40 drives (turns ON), for example, the compressor 21, the internal blower fan 12, and the external blower fan 24. Note that upon determination in STEP 1 that T1<TS (NO in STEP 1), the process stands by until T1>TS is reached.

In Step 3, the control unit 40 determines whether or not the lower space temperature T1 is smaller than a value TH (hereinafter referred to as an upper-limit air temperature) obtained by adding the target value ΔTs of the temperature difference ΔT to the upper-limit refrigerant temperature T3H. Upon determination that T1<TH (YES in Step 3), the control unit 40 proceeds to Step 3. Upon determination that T1≥TH (NO in Step 3), the control unit 40 outputs an aperture adjustment signal to the electronic expansion valve 23a so that the aperture S of the electronic expansion valve 23a may become the maximum aperture Smax (Step 3a). The electronic expansion valve 23a maintains the aperture S at the maximum aperture Smax until YES is determined in Step 3. Upon determination that T1<TH (YES in Step 3), the process proceeds to Step 4.

In Step 4, the control unit 40 calculates the refrigerant evaporation temperature T3 by subtracting the target value ΔTs of the temperature difference ΔT from the lower space temperature T1, determines, based on, for example, the preset data or arithmetic equation, the aperture S corresponding to the refrigerant evaporation temperature T3 obtained through the aforementioned calculation, and the process proceeds to Step 5.

In Step 5, the control unit 40 outputs a control signal to the electronic expansion valve 23a to achieve the determined aperture S, and the process proceeds to Step 6. In Step 5, the electronic expansion valve 23a makes adjustment based on the control signal output from the control unit 40 so that the aperture S becomes the aperture S determined by the control unit 40. Since the aperture S provided before the changing is the maximum aperture Smax, the aperture S is to be narrowed down.

In Step 6, the control unit 40 determines whether or not the lower space temperature T1 is equal to or smaller than the set temperature TS. Upon determination that T1>TS (NO in STEP 6), the process returns to Step 4 to calculate a next refrigerant evaporation temperature T3 and also determine aperture S corresponding to the calculated T3, further narrowing down the aperture S of the electronic expansion valve 23a. Then until reaching T1≤TS (YES in Step 6), the control unit 40 repeatedly executes Step 4 and Step 5 to gradually narrow down the electronic expansion valve 23a. Upon determination that T1≤TS (YES in Step 6), the process proceeds to Step 7.

In Step 7, the control unit 40 maintains the aperture S of the electronic expansion valve 23a, and stops (turns off), for example, the compressor 21, the internal blower fan 12, and the external blower fan 24 in Step 8. Specifically, since the temperature of the lower space is equal to or smaller than −5° C. at this point, the control unit 40 stops the cooling device 30. Since the product storage chamber 1a has the heat-insulated structure, T1>TS is not reached immediately even after the cooling device 30 is stopped. Then the process proceeds to Step 9.

In Step 9, the control unit 40 determines whether or not the lower space temperature T1 is greater than the set temperature TS. Upon determination that T1≤TS (NO in Step 9), the process returns to Step 7 to continue to maintain the aperture S and also stop the compressor 21, and the like. Then the temperature of the lower space gradually increases. Upon determination that T1>TS (YES in Step 9), the process returns to Step 2 to drive (turn on) the compressor 21, and the like, and proceeds to Step 3. The control unit 40 determines at this point that T1<TH (YES in Step 3), and determines next aperture S through Step 4 and Step 5. The aperture S provided before the changing at this point is the aperture which is maintained from Step 7 and which is provided upon the determination that T1≤TS. On the other hand, the aperture S obtained after the changing is aperture obtained upon the determination that T1>TS (the previous Step 9). Thus, the aperture S obtained after the changing is greater than the aperture S provided before the changing. Therefore, in this case, the aperture S of the electronic expansion valve 23a is consequently opened. Then the process proceeds to Step 6, and thereafter repeatedly executes each of the steps described above.

As a result, the temperature of the lower space (T1) is held near the set temperature TS, and also the temperature difference ΔT between the lower space temperature T1 as the temperature of the inside of the product storage chamber 1a and the refrigerant evaporation temperature T3 is maintained near the target value ΔTs. As described above, the cooling device 30 is able to perform the partial cooling operation in a state in which the temperature difference ΔT is within the predetermined range (for example, approximately 8° C. to 13° C.).

Next, the entire cooling operation will be described in detail.

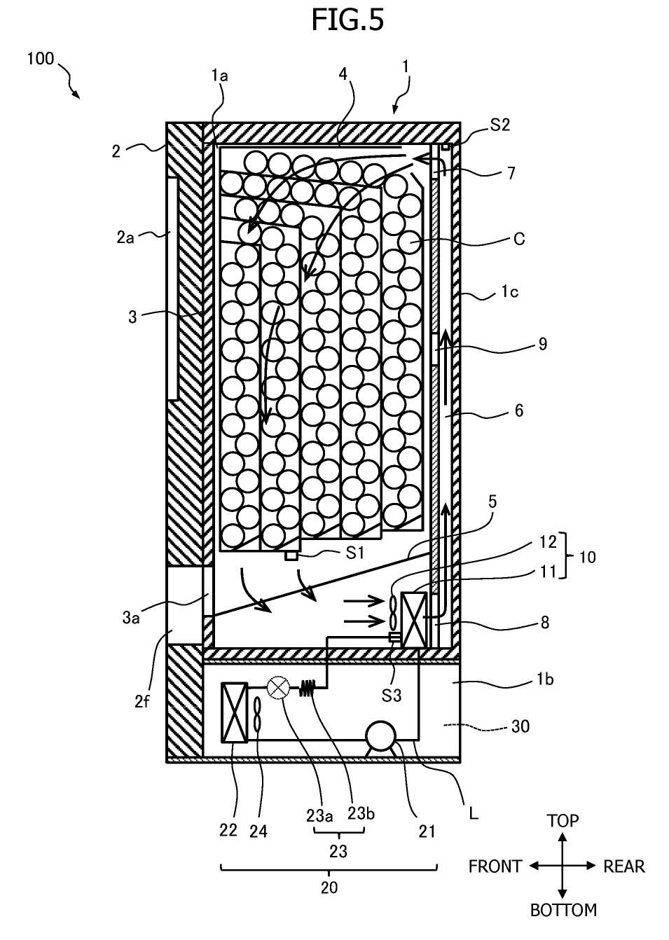

To execute the entire cooling operation, the control unit 40 drives the internal blower fan 12 into reverse rotation and also actuates the compressor 21 and the external blower fan 24. Then, as illustrated in FIG. 5, the air inside the product storage chamber 1a circulates inside the product storage chamber 1a in a manner such as to flow into the back-side duct 6 from the lower opening part 8, upwardly pass through the inside of the back-side duct 6, flows out from the upper opening part 7, and flows into the back-side duct 6 from the lower opening part 8 again. That is, the air in the product storage chamber 1a circulates in a direction opposite to a direction in the case of the partial cooling operation. In the present case, the air cooled by the internal heat exchanger 11 flows out from the upper opening part 7 of the back-side duct 6, passes between the bottled beverages C stored in each product storage column of the product storage device 4 downwardly from the top to the bottom, is cooled by the internal heat exchanger 11, and then travels towards the lower opening part 8. Therefore, the entire inside of the product storage chamber 1a is cooled and all the bottled beverages C stored in the product storage device 4 are also cooled.

The control unit 40 is also able to execute the aperture control upon the entire cooling operation. Now operation of the control unit 40 will be described below, assuming a case in which switching to the entire cooling operation is made when the lower space temperature T1 is held at the set temperature TS (for example, −5° C.) and the upper space temperature T2 is higher than the set temperature TS by executing the partial cooling operation.

Upon the execution of the entire cooling operation, the control unit 40 uses, as the temperature difference ΔT, a difference between the temperature measured by the temperature sensor S2 (the upper space temperature T2) and the refrigerant evaporation temperature T3. The upper space temperature T2 instead of the lower space temperature T1 is used as the temperature of the inside of the product storage chamber 1a in the aperture control performed by the control unit 40 upon the execution of the entire cooling operation. The aforementioned point is only a point different from a case of the control unit 40 performing the partial cooling operation.

For example, as a result of adopting the aperture S according to the refrigerant evaporation temperature T3 obtained by subtracting the target value ΔTs of the temperature difference ΔT from the lower space temperature T1 when the upper space temperature T2 is higher than the set temperature TS (=T1), cool air generated at the internal heat exchanger 11 is supplied to the upper space from the upper opening part 7 and heat-exchanged with the air present at the temperature T2 (>T1) in the upper space, leading to a possibility that the actual temperature difference ΔT becomes excessively large.

The control unit 40 in the present embodiment adopts, as a representative temperature of the inside of the product storage chamber 1a, an actual temperature (T2) of the upper space into which the cool air generated at the internal heat exchanger 11 directly flows through the back-side duct 6 when the upper space temperature T2 is higher than the set temperature TS, for example, immediately after switching from the partial cooling operation to the entire cooling operation. Then the control unit 40 calculates the refrigerant evaporation temperature T3 by subtracting the target value ΔTs of the temperature difference ΔT from not the lower space temperature T1 but the upper space temperature T2, and also determines the aperture S corresponding to the calculated T3 to execute the aperture control of the electronic expansion valve 23a.

With the automatic vending machine 100 according to the present embodiment, the expansion mechanism 23 for a refrigerant in the cooling device 30 has, in the refrigerant pipe L, the electronic expansion valve 23a which is able to adjust the aperture S, and the aperture S of the electronic expansion valve 23a is controlled by the control unit 40 in a manner such that the temperature difference ΔT between the lower space temperature T1 as the temperature of the inside of the product storage chamber 1a and the refrigerant evaporation temperature T3 is within the predetermined range in both the case of the partial cooling operation and the case of the entire cooling operation. Thus, the automatic vending machine 100 is able to execute the partial cooling operation and the entire cooling operation by making the temperature difference ΔT between the actual temperature of the air around the products inside the product storage chamber 1a and the refrigerant evaporation temperature T3 within the predetermined range. Therefore, for example, even upon an increase in the actual temperature of the inside of the chamber caused by the outer air inflow, the automatic vending machine 100 is capable of adjusting the aperture S of the electronic expansion valve 23a according to the increased temperature to increase the refrigerant evaporation temperature T3 and thereby making the temperature difference ΔT fall within the predetermined range in both the case of the partial cooling operation and the case of the entire cooling operation.

Therefore, the automatic vending machine 100 is able to reduce the energy required for cooling the entire or partial inside of the chamber even in a situation that the temperature difference between the actual temperature of the air around the products inside the product storage chamber 1a and the refrigerant evaporation temperature may become larger.

Furthermore, with the present embodiment, as described above, even in a situation in which there is, for example, a temperature gradient inside the product storage chamber 1a and upon switching of the operation method, the temperature difference ΔT between the temperature of the air measured from the temperature sensor (the representative temperature of the inside of the product storage chamber 1a) and the refrigerant evaporation temperature T3 may become larger depending on a place of the temperature sensor adopting the representative temperature of the inside of the product storage chamber 1a, selection of the temperature sensor located at an appropriate position permits the temperature difference ΔT to fall within the predetermined range and also permits the reduction of the energy required for cooling the inside of the chamber.

Moreover, the switching between the partial cooling operation and the entire cooling operation is made simply by reversing the rotation direction of the single internal blower fan 12 in the present embodiment. Thus, a cost increase of the automatic vending machine 100 due to an increase in a number of components is prevented.

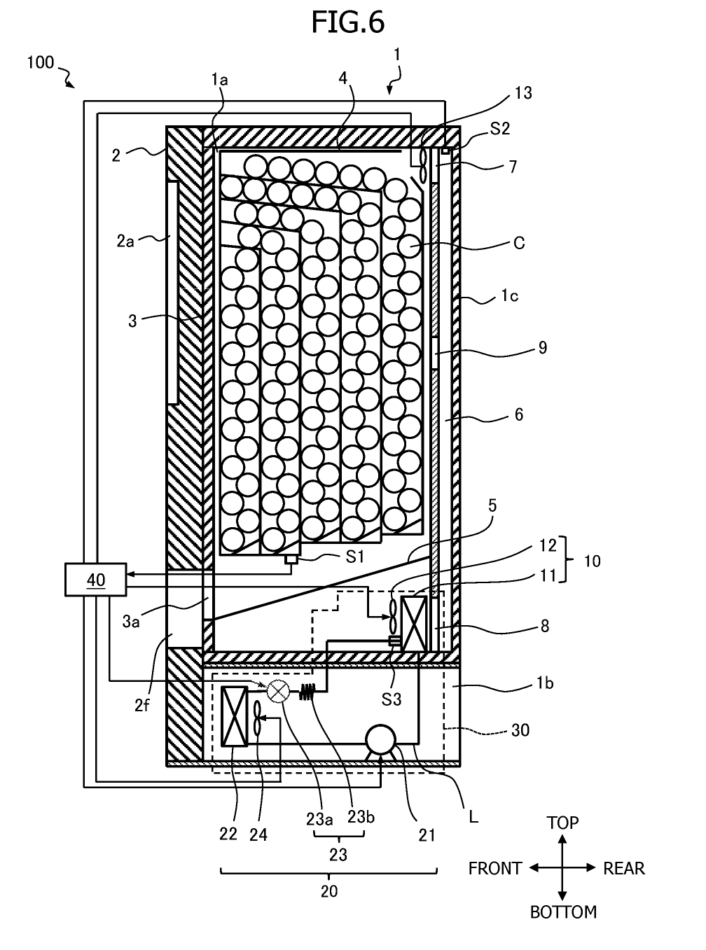

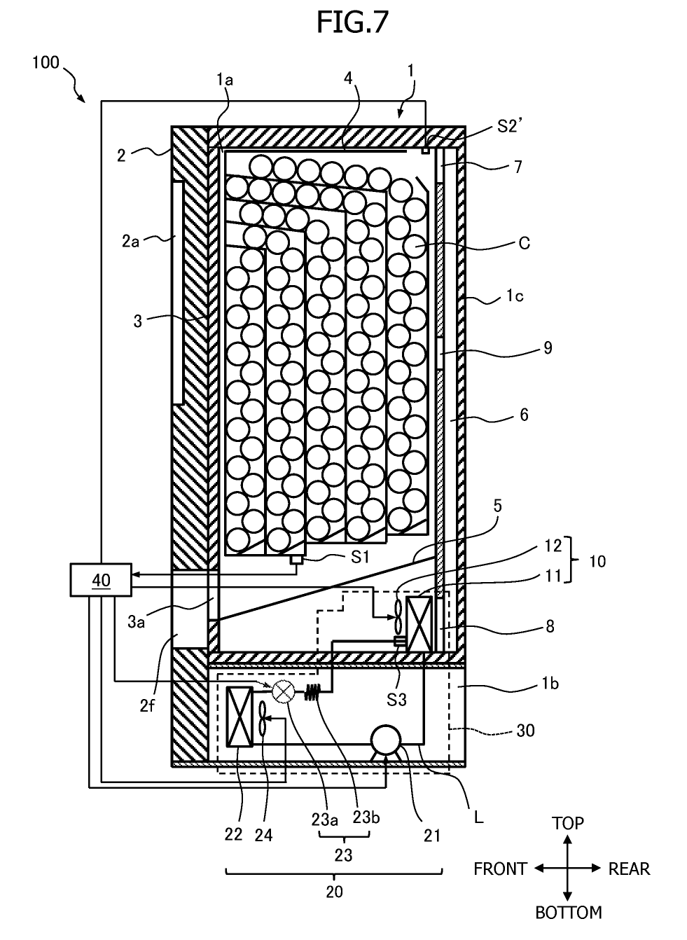

Next, modified examples of the present embodiment will be described with reference to FIGS. 6 and 7.

### MODIFIED EXAMPLE 1

In the embodiment described above, the single internal blower fan 12 is provided as a circulating fan which circulates the air inside the product storage chamber 1a. However, an internal blower fan is not limited to the internal blower fan 12, and an additional internal blower fan 13 may be provided inside the product storage chamber 1a. As illustrated in FIG 6, the additional internal blower fan 13 is preferably provided in vicinity of the upper opening part 7 of the back-side duct 6. Here, the additional internal blower fan 13 is a fan which sends airflow from the back side to the front side of the product storage chamber 1a.

In this, the control unit 40 drives the internal blower fan 12 into normal rotation upon the execution of the partial cooling operation, and drives the internal blower fan 12 into reverse rotation and also actuates the additional internal blower fan 13 upon the execution of the entire cooling operation. Modified Example 1 also provides the same effects as effects provided by the embodiment described above.

### MODIFIED EXAMPLE 2

In the embodiment described above, the temperature sensor S2 is provided in the back-side duct 6, although not limited thereto, and as illustrated in FIG. 7, the temperature sensor S2 may also be provided in vicinity of the upper opening part 7 outside the back-side duct 6. Moreover, an additional internal blower fan 13 may be provided in Modified Example 2, as is the case with Modified Example 1. The aforementioned modified examples also provide the same effects as the effects provided by the embodiment described above.

Note that the above description refers to a case in which the automatic vending machine 100 sells the bottled beverages C in an supercooled state as products based on the assumption that the set temperature TS of the inside of the product storage chamber 1a is set to be equal to or less than the solidification point of the bottled beverages C; however the set temperature TS is not limited to the aforementioned temperature and may be equal to or greater than the solidification point of the bottled beverages C. Moreover, the products cooled for sale are not limited to beverages. Even in the aforementioned cases, performing the driving control of the cooling device 30 with the controlled temperature difference ΔT provides the same effects as the effects provided by the embodiment described above.

Hereinabove, although the embodiment of the present invention and the modified examples thereof have been described, the present invention is not limited to the above-mentioned embodiment and modified examples, and can be variously modified and changed based on the technical concept of the present invention.

### REFERENCE SYMBOL LIST

1a Product storage chamber (Heat-insulated chamber)
4 Product storage device
6 Back-side duct
7 Upper opening part
8 Lower opening part
9 Middle opening part
11 Internal heat exchanger (Evaporator)
12 Internal blower fan (Circulating fan)
21 Compressor
22 External heat exchanger (Condenser)
23 Expansion mechanism
23a Electronic expansion valve
30 Cooling device
40 Control unit
100 Automatic vending machine
S1 First temperature measuring unit (First temperature sensor)
S2 Second temperature measuring unit (Second temperature sensor)
T1 Temperature of lower space (Lower space temperature)
T2 Temperature of upper space (Upper space temperature)
T3 Refrigerant evaporation temperature

1. An automatic vending machine comprising:
a product storage device which is arranged inside a heat-insulated chamber, and which vertically arrays and stores a plurality of products, and also sequentially dispenses the plurality of products starting with the product located at a lowermost part; a cooling device which cools the plurality of products; a control unit which controls the cooling device; and a back-side duct which is disposed on a back-side inside the heat insulation chamber and extends heightwise of the heat-insulated chamber, wherein
the cooling device has: a compressor which compresses a refrigerant; a condenser which condenses the compressed refrigerant; an expansion mechanism which expands the condensed refrigerant; and an evaporator which is provided at a lower part inside the heat-insulated chamber and evaporates the refrigerant to cool ambient air, and the cooling device cools the plurality of products by cooling air inside the heat-insulated chamber and also circulating the air through the back-side duct,
the expansion mechanism has an electronic expansion valve which is able to adjust aperture of a refrigerant flow path, and
in both a case of partial cooling operation for cooling the product located on a lower side of the plurality of products by driving the cooling device and a case of the entire cooling operation for cooling the entirety of the plurality of products, the control unit controls aperture of the electronic expansion valve so that a temperature difference between a temperature of the inside of the heat-insulated chamber and a refrigerant evaporation temperature of the evaporator is within a predetermined range.

2. The automatic vending machine according to claim 1, further comprising:
a first temperature measuring unit for measuring a temperature of a lower space inside the heat-insulated chamber; and
a second temperature measuring unit for measuring a temperature of an upper space inside the heat-insulated chamber, wherein
the control unit uses, as the temperature difference, a difference between the temperature measured by the first temperature measuring unit and the refrigerant evaporation temperature in the case of the partial cooling operation, and uses, as the temperature difference, a difference between the temperature measured by the second temperature measuring unit and the refrigerant evaporation temperature in the case of the entire cooling operation.

3. The automatic vending machine according to claim 2, wherein
the back-side duct has: an upper opening part which opens at an upper part inside the heat-insulated chamber; a lower opening part which opens at the lower part inside the heat-insulated chamber; and a middle opening part which opens between the upper opening part and the lower opening part,
the evaporator is disposed in a vicinity of the lower opening part of the back-side duct,
when the partial cooling operation is performed, the air inside the heat-insulated chamber circulates so as to flow into the back-side duct from the middle opening part, pass through the back-side duct, and then flow out from the lower opening part, and
when the entire cooling operation is performed, the air inside the heat-insulated chamber circulates so as to flow into the back-side duct from the lower opening part, pass through the back-side duct, and then flow out from the upper opening part.

4. The automatic vending machine according to claim 3, wherein
the cooling device includes a circulating fan which circulates the air inside the heat-insulated chamber, and
the control unit reverses a rotation direction of the circulating fan between the partial cooling operation and the entire cooling operation.

5. The automatic vending machine according to claim 2 4, wherein
the first temperature measuring unit is provided in a vicinity of a lower part of the product storage device, and
the second temperature measuring unit is provided in a vicinity of the upper opening part inside or outside the back-side duct.
